(19) United States
(12) Patent Application Publication
(10) Pub. No.: US 2020/0252222 A1
(43) Pub. Date: Aug. 6, 2020

(54) METHOD AND DEVICE FOR TRANSMITTING FORM REQUEST

(71) Applicant: Wangsu Science & Technology Co., Ltd., Shanghai (CN)

(72) Inventor: Meifen HUANG, Shanghai (CN)

(21) Appl. No.: 16/858,059

(22) Filed: Apr. 24, 2020

Related U.S. Application Data
(63) Continuation of application No. PCT/CN2018/091580, filed on Jun. 15, 2018.

(30) Foreign Application Priority Data
May 24, 2018 (CN) 201810509555.7

(51) Int. Cl. H04L 9/32; H04L 29/06; G06F 21/64

(52) U.S. Cl. CPC H04L 9/3247; G06F 21/64; H04L 63/123; H04L 63/0428

(57) ABSTRACT

The present disclosure relates to the field of data transmission technology, a method and device for transmitting a form request are disclosed. The method includes: generating signature information based on a preset read-only parameter of a form in a target response page when receiving the target response page fed back by a server; adding the signature information to the form of the target response page and transmitting the target response page to a terminal; receiving a target form request corresponding to the target response page transmitted by the terminal and verifying the signature information in a form included in the target form request; and transmitting the target form request to the server if the verification is successful, otherwise performing a prevention process on the target form request. The present disclosure can improve the security of submission of the form.

### CROSS-REFERENCE TO RELATED APPLICATIONS

The present application is a continuation of PCT Patent Application No. PCT/CN2018/091580, filed Jun. 15, 2018, entitled “METHOD AND DEVICE FOR TRANSMITTING FORM REQUEST,” which claims priority to Chinese Patent Application No. 201810509555.7, filed May 24, 2018, entitled “METHOD AND DEVICE FOR TRANSMITTING FORM REQUEST,” each of which is incorporated by reference herein in its entirety.

### TECHNICAL FIELD

The present disclosure relates to the field of data transmission technology, in particular, to a method and device for transmitting a form request.

### BACKGROUND

With the rapid development of the Internet and computer technologies, and people living an increasingly faster pace of life, e-commerce has become a trend of commodity transactions, and network transactions are becoming more and more popular. Users can realize network transactions by performing a series of operations such as visiting e-commerce websites, selecting commodities, submitting orders, and making payments.

A process of submitting an order using network transactions is essentially a process of transmitting a form. The user may request an order page from an e-commerce web site through a terminal, and a server of the e-commerce website can feed back a corresponding order page to the terminal (the order page may be called a response page). The order page may include one or more forms. After the terminal receives and displays the order page, the user may input in the order page corresponding order information such as the number of commodities being purchased, a style of a commodity, etc., and then the terminal may fill the order information in a corresponding form and transmit the form to the server of the e-commerce website.

The inventor finds at least the following problems in existing technology. A server of an e-commerce website can more or less have vulnerabilities such as a system defect and a logic error, and these vulnerabilities are often taken advantage of by lawbreakers to conduct malicious transactions, during which the lawbreakers, after obtaining an order page from the server of the e-commerce website, could maliciously tamper parameters in a form such as a value of a commodity. As a result, security of the network transaction is compromised.

### SUMMARY

In order to solve the problem in the existing technology, embodiments of the present application provide a method and device for transmitting a form request, the technical solutions are described below.

According to some embodiments, a method for transmitting a form request comprises:

generating signature information based on a preset read-only parameter of a form in a target response page when receiving the target response page fed back by a server;

adding the signature information to the form of the target response page and transmitting the target response page to a terminal;

receiving a target form request corresponding to the target response page transmitted by the terminal and verifying the signature information in a form included in the target form request; and

transmitting the target form request to the server if the verification is successful, otherwise performing a prevention process on the target form request.

In some embodiments, receiving the target form request corresponding to the target response page transmitted by the terminal and verifying the signature information in the form included in the target form request includes:

receiving the target form request corresponding to the target response page transmitted by the terminal and obtaining request information of the target form request, where the request information at least includes a URL corresponding to the target form request, a parameter format of the preset read-only parameter and the signature information;

determining whether the target form request is a form request to be prevented based on the request information and a form request learning table stored locally; and
verifying the signature information in the form included in the target form request if the target form request is a form request to be prevented.

In some embodiments, the form request learning table records request information of all form requests obtained that need to be prevented after being processed by big-data and machine learning.

In some embodiments, the method further includes:

inserting the request information in the form request learning table and recording the target form request is in a learning phase, if the request information of the target form request corresponding to the target response page does not exist in the form request learning table when receiving the target response page fed back by the server.

In some embodiments, after inserting the request information in the form request learning table, further including:

determining target form requests as form requests to be prevented if the target form requests carrying signature information that are transmitted by at least a preset number of different terminals are received within a preset duration.

In some embodiments, verifying the signature information in the form included in the target form request includes:

determining whether the signature information in the form included in the target form request can be decrypted based on a preset decryption algorithm, whether a decrypted parameter information is consistent with the preset read-only parameter, and whether the request information of the target form request is consistent with the request information of the target form request recorded in the form request learning table.

In some embodiments, the method further includes:

determining a transmission terminal of the target form request if the target form request is a form request to be prevented and the target form request does not carry signature information;

determining the number of un-signed times of form requests corresponding to the transmission terminal; and

performing a prevention process on the target form request if the number of un-signed times is greater than a preset threshold, otherwise adding the number of un-signed times by one.

In some embodiments, the method further includes:

seeking whether a same request information item is available in the form request learning table stored locally, and determining whether the target form is the form request to be prevented; verifying the signature information in the form included in the target form request if YES; alternatively, transmitting the target form request directly to the server if NO.

In some embodiments, the method further includes:

recording form information of a form request that does not need to be prevented, and form information of a form request in a learning phase, by the form request learning table;

tagging each form information accordingly; and

determining whether a current form request is a form request to be prevented based on a corresponding tag when request information item of a certain form request is found in the form request learning table.

In some embodiments, the method further includes:

decrypting the signature information in the form included in the target form request based on the preset decryption algorithm;

considering the signature information has been modified if the decryption is not performed normally; and

preventing the target form request.

In some embodiments, the method further includes:

determining whether a decrypted parameter information is consistent with the preset read-only parameter of a corresponding form if the decryption is performed normally;

considering the signature information has been modified if it is inconsistency; and
preventing the target form request.

In some embodiments, the method further includes:

extracting request information of the target form request if the decrypted parameter information is consistent with the preset read-only parameter of the corresponding form;

determining whether the request information of the target form request is consistent with the request information of the target form request recorded in the form request learning form; and

preventing the target form request if it is inconsistency.

In some embodiments, the method further includes:

deleting the signature information in the target form request if the verification is successful; and

transmitting the target form request to the server.

transmitting the target form request to the server if the verification is successful, alternatively, performing a prevention process on the target form request.

In some embodiments, a device for transmitting a form request comprises:

a generating module, configured to generate signature information based on a preset read-only parameter of the form in a target response page when receiving the target response page fed back by a server;

a transmitting module, configured to add the signature information to the form of the target response page and transmit the target response page to a terminal;

a verifying module, configured to receive a target form request corresponding to the target response page transmitted by the terminal and verify the signature information in the form included in the target form request; and

a preventing module, configured to transmit the target form request to the server if the verification is successful, otherwise perform a prevention process on the target form request.

In some embodiments, the verifying module is specifically configured to:

receive the target form request corresponding to the target response page transmitted by the terminal and obtain request information of the target form request, where the request information at least includes a URL corresponding to the target form request, a parameter format of the preset read-only parameter and the signature information;

determine whether the target form request is a form request to be prevented based on the request information and a form request learning table stored locally; and

verify the signature information in the form included in the target form request if the target form request is a form request to be prevented.

In some embodiments, the form request learning table records request information of all form requests that need to be prevented after being processed by big-data process and machine learning.

In some embodiments, the device further includes:

a learning module, configured to insert the request information in the form request learning table and record that the target form request is in a learning phase, if the request information of the target form request corresponding to the target response page does not exist in the form request learning table when the target response page fed back by the server is received.

In some embodiments, the learning module is further configured to:

determine target form requests as form requests to be prevented, if the target form requests carrying signature information that transmitted by at least a preset number of different terminals are received within a preset duration.

In some embodiments, the verifying module is specifically configured to:

determine whether the signature information in the form included in the target form request can be decrypted based on a preset decryption algorithm, whether parameter information obtained through the decryption is consistent with the preset read-only parameter, and whether the request information of the target form request is consistent with the request information of the target form request recorded in the form request learning table.

In some embodiments, the verifying module is further configured to:

determine a transmission terminal of the target form request if the target form request is a form request to be prevented and the target form request does not carry signature information;

determine the number of un-signed times of form requests corresponding to the transmission terminal; and

perform a prevention process on the target form request if the number of un-signed times is greater than a preset threshold, otherwise add the number of un-signed times by one.

The present disclosure according to some embodiments provides a WAF device including a processor and a memory. The memory stores at least one instruction, at least one program and a code set or an instruction set, and the at least one instruction, the at least one program and the code set or the instruction set are loaded by the processor and are executed to implement the method for transmitting the form request as described above.

The present disclosure according to some embodiments provides a computer readable storage medium, storing at least one instruction, at least one program and a code set or an instruction set. The at least one instruction, the at least one program and the code set or the instruction set are loaded by the processor and are executed to implement the method for transmitting the form request as described above.

The technical solutions provided in the embodiments of the present application have the following advantageous effects.

In some embodiments, signature information is generated based on a preset read-only parameter of a form in a target response page when receiving the target response page fed back by a server. The signature information is added to the form of the target response page and the target response page is transmitted to the terminal. A target form request corresponding to the target response page transmitted by the terminal is received, and the signature information in a form included in the target form request is verified. The target form request is transmitted to the server if the verification is successful, otherwise a prevention process is performed on the target form request. In this way, the signature information is added to the form in advance. When the form request is received, the form information is used to verify whether the form is tampered with maliciously, so that an abnormal form request may be detected in time and prevented, which can improve security of submission of the form. In addition, by performing big-data learning with respect to varied form requests and adding signature and prevention to the form requests based on a learning result, a malicious data packet can be found and a corresponding prevention measure can be implemented in time.

### BRIEF DESCRIPTION OF THE DRAWINGS

In order to illustrate the technical solutions in the embodiments of the present disclosure more clearly, the drawings used in the description of the embodiments will be briefly described below. It is obvious that the drawings in the following description are only some embodiments of the present disclosure. For those skilled in the art, other drawings may also be obtained based on these drawings without any inventive effort.

FIG. 1 is a schematic diagram of a scenario framework for transmitting a form request according to an embodiment of the present disclosure.

FIG. 2 is a flowchart of a method for transmitting a form request according to an embodiment of the present disclosure.

FIG. 3 is a schematic workflow of validating signature information according to an embodiment of the present disclosure.

FIG. 4 is a schematic structural diagram of a device for transmitting a form request according to an embodiment of the present disclosure.

FIG. 5 is a schematic structural diagram of a device for transmitting a form request according to another embodiment of the present disclosure.

FIG. 6 is a schematic structural diagram of a WAF device according to an embodiment of the present disclosure.

### DETAILED DESCRIPTION

To make the objectives, the technical solutions and the advantages of the present disclosure more clearer, the embodiments of the present disclosure will be further described in details below with reference to the accompany drawings.

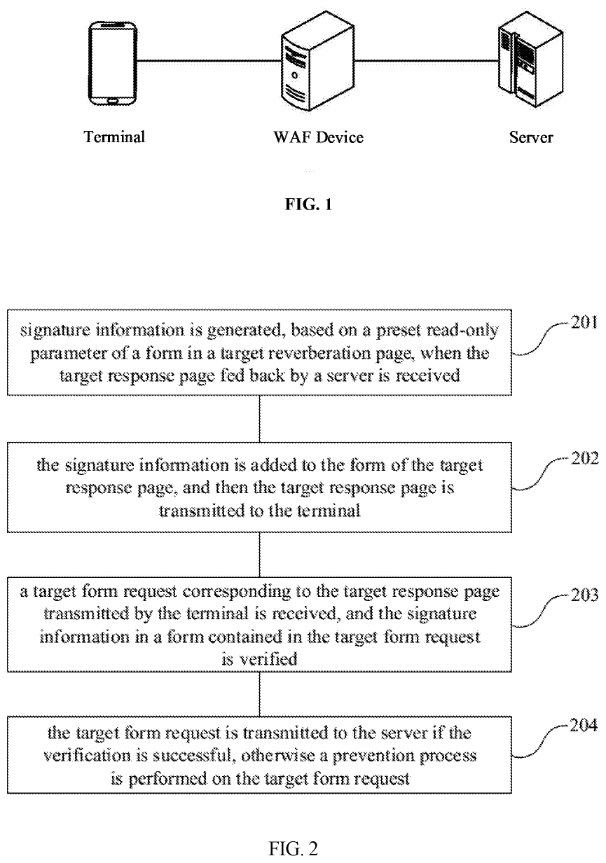

An embodiment of the present disclosure provides a method for transmitting a form request. An entity that implements the method may be a web application firewall (WAF) device. Herein, the WAF device may be deployed in a network transmission path between a server and a terminal. The terminal may be installed with a client of a web application, and the server may be a background server of the web application. The WAF device may be understood as a WAF which is configured to detect and verify a content of various requests transmitted by the terminal to the server to ensure their security and legality and to block illegal requests in real time. The WAF may be a system composed of a plurality of WAF devices. Each WAF device may be a physical entity device or a virtual device created dependent on a physical entity device. A particular network framework may be one as shown in FIG. 1. The WAF device may include a processor, a memory and a transceiver. The processor may be configured to perform a process of transmitting a form request in a following procedure. The memory may be configured to store data required in the following processing and generate data. The transceiver may be configured to receive and transmit relevant data in the following processing. In order to facilitate understanding, in an embodiment, that the web application is an online shopping application is taken as an example for description. Other web applications are similar to this, and special description will be made where necessary.

The process flow shown in FIG. 2 will be described in detail below with reference to particular embodiments, which may be as follows.

In step 201, signature information is generated, based on a preset read-only parameter of a form in a target response page, when the target response page fed back by a server is received.

Herein, the response page may be a page fed back by the server to the terminal with respect to a page acquisition request after the terminal transmits the page acquisition request to the server. The preset read-only parameter may be a non-editable parameter pre-selected from the form by a technician at a WAF device side.

In implementation, a user may install a client of an online shopping application on the terminal, and may then through the client access the server of the online shopping application, and request at the server web pages provided such as a commodity list page, a commodity detail page and a purchase page. Specifically, after the user clicks a key on the terminal, the terminal may be triggered to transmit the page acquisition request to the server. After receiving the page acquisition request, the server may feed back a corresponding page (i.e., the target response page) to the terminal. In this way, after receiving the target response page fed back to the terminal by the server, the WAF device may match and obtain a content of the form on the target response page, extract the preset read-only parameter of the form, and thus may generate the signature information based on the extracted preset read-only parameter. For example, the response page includes the following form:

<formid=″formid”name=“myform”method=′post′action=‘testURL’>

<inputtype=″hidden″name=″name1″value=″value1″/>
<inputtype=″text″readonlyname=″name2″value=″value2″/>
<inputtype=″text″readonly=″true″name=″name3″value=″value3″/>
<inputtype=″submit″value=″″class=″btn2″/>

</form>

The WAF device may extract the preset read-only parameter (name 1, value 1, name 2, value 2, name 3 and value 3), then perform a signature process on the preset read-only parameter through a relevant algorithm, and generate a signature information: <inputtype=“hidden”name=“flag”value=“encodeValue”/>.

In step 202, the signature information is added to the form of the target response page, and then the target response page is transmitted to the terminal.

In implementation, the WAF device, after generating the signature information based on the preset read-only parameter of the form, may add the signature information into the form, and may then transmit the target response page including the form added with the signature information to the terminal. It shall be noted that if the response page including a plurality of forms, signature information may be generated with respect to each form and the signature information may be added to a corresponding form. In this way, the signature information is added to each form on the response page.

In step 203, a target form request corresponding to the target response page transmitted by the terminal is received, and the signature information in a form included in the target form request is verified.

In implementation, the terminal, after receiving the target response page transmitted by the WAF device, may display the target response page. After the user performs input in an input box on the target response page, the terminal may fill data input by the user into a form corresponding to the target response page. After the user inputs and clicks a confirmation key, the terminal may transmit to the WAF device the target form request corresponding to the target response page. In this way, the WAF device, after receiving the target form request, may extract the signature information in the form included in the target form request and verify the signature information. It may be appreciated that the signature information here is the signature information added to the form at step 202, the terminal only fills in the form the data input by the user but does not make any change to the signature information in the form, and thus the signature information is available in the form included in the target form request.

Optionally, the WAF device may only prevent an assigned form request. Correspondingly, a process of step 203 may be as follows: receiving the target form request corresponding to the target response page transmitted by the terminal and obtaining request information of the target form request; determining whether the target form request is a form request to be prevented based on the request information and a form request learning table stored locally; and verifying the signature information in the form included in the target form request if the target form request is a form request to be prevented.

Herein, the request information at least includes a uniform resource locator (URL) corresponding to the target form request, a parameter format of the preset read-only parameter and the signature information.

In implementation, the WAF device may pre-store the form request learning table which records request information of all form requests obtained that need to be prevented after being processed by big-data and machine learning. In this way, the WAF device, after receiving the target form request corresponding to the target response page transmitted by the terminal, may first acquire such request information as the URL corresponding to the target form request, the parameter format (such as the integer type, enumeration and the characters, and so on) of the preset read-only parameter and the signature information, etc., and then the form request learning table stored locally may be sought for whether the same request information item is available, so as to determine whether the target form request is the form request to be prevented. If it is, the signature information in the form included in the target form request may be verified. If it is not, the target form request may be directly transmitted to the server. It shall be noted that apart from the form information of the form request that need to be prevented, the form request learning table may further record form information of the form request that does not need to be prevented and form information of the form request in a learning phase. Besides, each form information is tagged accordingly, so that when a request information item of a certain form request is found in the form request learning table, it may be determined whether a current form request is a form request to be prevented based on a corresponding tag. Herein, for each form request to be prevented, its corresponding page shall be set as forced not to cache so as to avoid a terminal's caching a relevant page affecting a following verification of the signature information.

Optionally, when a certain response page is received for the first time, its corresponding form request may be added to the form request learning table, and a corresponding process may be as follows: inserting the request information in the form request learning table and recording that the target form request is in a learning phase, if the request information of the target form request corresponding to the target response page does not exist in the form request learning table when the target response page fed back by the server is received.

In implementation, the WAF device, when receiving the target response page fed back by the server to the terminal, may first determine the target form request corresponding to the target response page, and then acquire the request information of the target form request. After that, the WAF device may call the form request learning table locally stored and search the form request learning table for whether the request information of the target form request is available. If no, the WAF device may insert the request information of the above target form request in the form request learning table, and record that the target form request is in the learning phase. If yes, the WAF device may directly forward the target response page to the terminal, to wait for the terminal to send the target form request, and to perform subsequent processing.

Optionally, if a form request sent by several terminals carries signature information, it means that the form request need to be prevented, and a corresponding process may be as follows: determining target form requests as form requests to be prevented if the target form requests carrying signature information and that transmitted by at least a preset number of different terminals are received within a preset duration.

In implementation, the WAF device, after adding the request information of the target form request to the form request learning table, may record the number of terminals that send target form requests carrying the signature information. If the target form requests that carry signature information and that are transmitted by at least a preset number of different terminals are received within a preset duration, the target form requests may be considered as needing a prevention process, and further, the WAF device may determine the target form requests as form requests to be prevented. It shall be noted that when the form requests carrying the signature information are received, if the request information of the form requests is unavailable in the form request learning table, the WAF device may insert the request information of the form requests into the form request learning table and record the number of the received form requests described above as 1.

Optionally, based on the processing of recording the request information of the form requests in the above form request learning table, the verification of the signature information in step 203 may specifically be as follows: determining whether the signature information in the form included in the target form request can be decrypted based on a preset decryption algorithm, whether parameter information obtained through the decryption is consistent with the preset read-only parameter, and whether the request information of the target form request is consistent with the request information of the target form request recorded in the form request learning table.

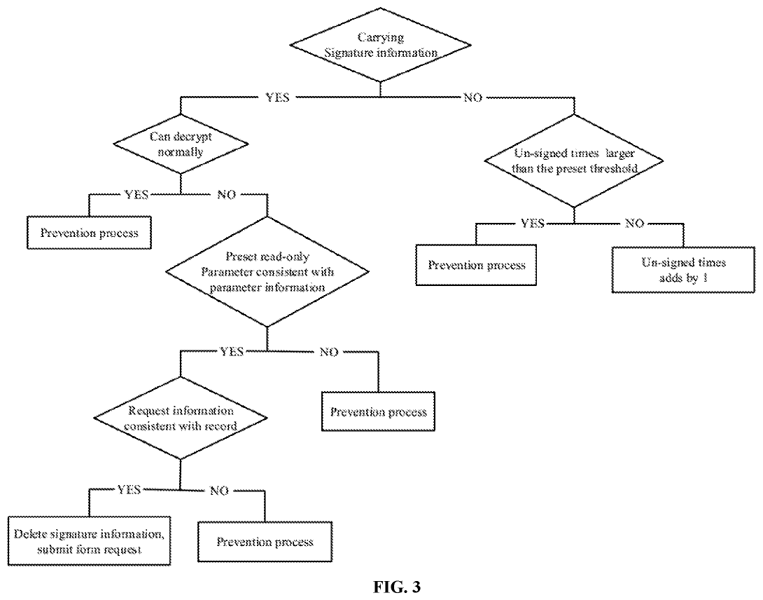

In implementation, the WAF device, after receiving the target form request corresponding to the target response page transmitted by the terminal, may extract the signature information in the form included in the target form request. Then the WAF device may call the preset decryption algorithm to decrypt the signature information. If the decryption cannot be performed normally, the signature information may be considered to have been modified, the target form request is likely to be a malicious request, and thus the prevention process may be performed on the target form request. However, if the decryption can be performed normally, it may be further determined whether the parameter information acquire through the decryption is consistent with the preset read-only parameter of the corresponding form. In case of inconsistency, the signature information may be considered to have been modified, the target form request is likely to be a malicious request, and thus the prevention process may be performed on the target form request. However, in a case of consistency, the request information of the target form request may be extracted, and it may be determined whether the request information of the target form request is consistent with the request information of the target form request recorded in the form request learning table. In a case of inconsistency, it shows that the target form request is an abnormal form request that needs to be prevented. However, in the case of consistency, the signature information in the target form request may be deleted, and then the target form request may be submitted to the server. It shall be noted that, if the WAF device receives the target form request and determines that the target form request is a form request to be prevented, and the target form request does not carry the signature information, the transmission terminal of the target form request may be determined before determining the number of transmission times of the form request corresponding to the transmission terminal that does not carry signature information (which also be called the number of un-signed times). If the number of un-signed times is greater than a preset threshold, the target form request may be prevented directly. If the number of un-signed times is less than or equal to the preset threshold, the number of un-signed times may be increased by one. A specific verification procedure of the above-described may be seen in FIG. 3.

In step 204, the target form request is transmitted to the server if the verification is successful, otherwise a prevention process is performed on the target form request.

In implementation, if the WAF device successfully verifies the signature information in the form included in the target form request, the target form request may be considered as a normal form request, the signature information in the target form request may be deleted, and then the target form request may be transmitted to the server. If the verification of the signature information in the form included in the target form request fails, it may be considered that the parameter of the form included in the target form request is maliciously modified, the received target form request may be a malicious request, and the WAF device may prevent the target form request. It shall be noted that a specific prevention process may be set manually by a technician at the WAF device side. For example, the prevention process may be a further manual review of the target form request, or the prevention process may intercept the target form request, or the prevention process may request the terminal to retransmit the target form request.

In embodiments of the present disclosure, signature information is generated, based on a preset read-only parameter of the form in a target response page, when the target response page fed back by a server is received. The signature information is added to the form of the target response page, and the target response page is transmitted to the terminal. A target form request corresponding to the target response page transmitted by the terminal is received, and the signature information in the form included in the target form request is verified. The target form request is transmitted to the server if the verification is successful, otherwise a prevention process is performed on the target form request. In this way, the signature information is added to the form in advance. When the form request is received, the signature information is used to verify whether the form is tampered with maliciously, so that an abnormal form request may be detected in time and prevented, which can improve security of submission of the form. In addition, through big-data learning with respect to varied form requests and adding signature and prevention to the form requests based on a learning result, a malicious data packet may be found and a corresponding prevention measure may be implemented in time.

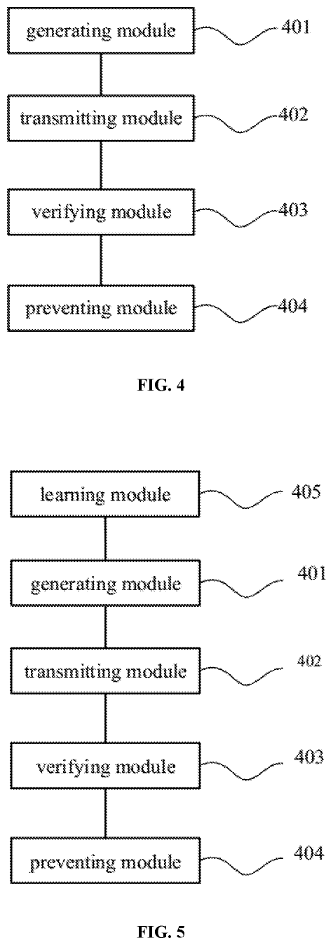

Based on the same technical concept, an embodiment of the present disclosure further provides a device for transmitting a form request. As shown in FIG. 4, the device includes:

a generating module 401, configured to generate signature information based on a preset read-only parameter of the form in a target response page when the target response page fed back by a server is received;

a transmitting module 402, configured to add the signature information to the form of the target response page, and transmit the target response page to a terminal;

a verifying module 403 configured to receive a target form request corresponding to the target response page transmitted by the terminal and verify the signature information in the form included in the target form request; and

a preventing module 404, configured to transmit the target form request to the server if the verification is successful, otherwise perform a prevention process on the target form request.

Optionally, the verifying module 403 is specifically configured to:

receive the target form request corresponding to the target response page transmitted by the terminal and obtain request information of the target form request, where the request information at least includes a URL corresponding to the target form request, a parameter format of the preset read-only parameter and the signature information;

determine whether the target form request is a form request to be prevented based on the request information and a form request learning table stored locally;

verify the signature information in the form included in the target form request if the target form request is a form request to be prevented.

Optionally, the form request learning table records request information of all form requests obtained that need to be prevented after being processed by big-data and machine learning.

Optionally, as shown in FIG. 5, the device further includes:

a learning module 405, configured to insert the request information in the form request learning table and record that the target form request is in a learning phase, if the request information of the target form request corresponding to the target response page does not exist in the form request learning table when the target response page fed back by the server is received.

Optionally, the learning module 405 is further configured to:

determine target form requests as form requests to be prevented if the target form requests carrying signature information that transmitted by at least a preset number of different terminals are received within a preset duration.

Optionally, the verifying module 403 is specifically configured to:

determine whether the signature information in the form included in the target form request can be decrypted based on a preset decryption algorithm, whether parameter information obtained through the decryption is consistent with the preset read-only parameter, and whether the request information of the target form request is consistent with the request information of the target form request recorded in the form request learning table.

Optionally, the verifying module 403 is further configured to:

determine a transmission terminal of the target form request if the target form request is a form request to be prevented and the target form request does not carry signature information;

determine the number of un-signed times of form requests corresponding to the transmission terminal; and

perform a prevention process on the target form request if the number of un-signed times is greater than a preset threshold, otherwise the number of un-signed times is increased by one.

In embodiments of the present disclosure, signature information is generated, based on a preset read-only parameter of the form in a target response page, when the target response page fed back by a server is received. The signature information is added to the form of the target response page, and the target response page is transmitted to the terminal. A target form request corresponding to the target response page transmitted by the terminal is received, and the signature information in the form included in the target form request is verified. The target form request is transmitted to the server if the verification is successful, otherwise a prevention process is performed on the target form request. In this way, the signature information is added to the form in advance. When the form request is received, the form information is used to verify whether the form is tampered with maliciously, so that an abnormal form request may be detected in time and prevented, which can improve security of submission of the form. In addition, through big-data learning with respect to varied form requests and adding signature and prevention to the form requests based on a learning result, a malicious data packet may be found and a corresponding prevention measure may be implemented in time.

It shall be noted that, the device for transmitting a form request provided in the above-described embodiment, when sending the form request, only uses the division of the above-described functional modules as an example for description. In practical applications, the above-mentioned function may be distributed to and completed by different functional modules based on what is needed. That is, the internal structure of the device is divided into varied functional modules to complete all or some functions as described above. In addition, the device for transmitting a form request provided in the above-described embodiment and the embodiments of the method for sending a form request belongs to the same concept. For specific implementation processes, please refer to the embodiments of the method and details are not repeated herein.

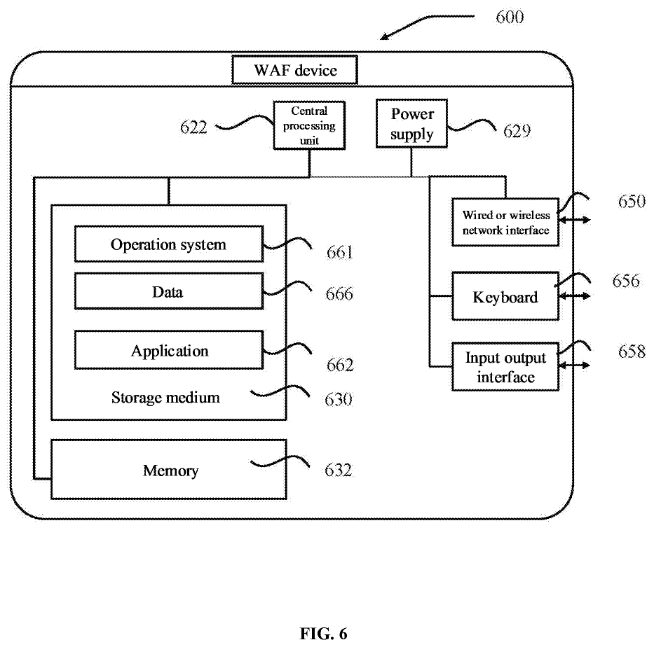

FIG. 6 is a schematic structural diagram of a WAF device based on an embodiment of the present disclosure. A WAF device 600 may result in a big difference due to differences in configuration or performance. The WAF device 600 may include one or more central processing units 622 (for example, one or more processors) and a memory 632, and one or more storage media 630 (e.g., one or more mass storage devices) that store a storage application 662 or data 666. Herein, the memory 632 and the storage medium 630 may be of transient storage or persistent storage. A program stored in the storage medium 630 may include one or more modules (not shown in the figure), and each module may include a series of instruction operations on the WAF device. Further, the central processing unit 622 may be configured to communicate with the storage medium 630 and execute a series of instructed operations in the storage medium 630 on the WAF device 600.

The WAF device 600 may further include one or more power supplies 626, one or more wired or wireless network interfaces 650, one or more input-output interfaces 658, one or more keyboards 656, and/or one or more operation systems 661, for example, Windows Server™, Mac OSX™, Unix™, Linux™, FreeBSD™ and so on.

The WAF device 600 may include a memory and one or more programs, where the one or more programs are stored in the memory and are configured to be executed by one or more processors to execute the one or more programs including instructions for performing the transmission of the above form requests.

Those skilled in the art may appreciate that all or some steps that realize the above-described embodiments may be implemented through hardware, or may be implemented by instructing related hardware through a program which may be stored in a computer readable storage medium. The storage medium may be a read-only memory, a magnetic disc, or a compact disc.

The above are only preferably embodiments of the present disclosure, but are not intended to limit the present disclosure. Any amendment, equivalent replacement, improvement etc. made within the principle of the present disclosure shall be included in the protection scope of the present disclosure.

What is claimed is:

1. A method for transmitting a form request, comprising:
generating signature information based on a preset read-only parameter of a form in a target response page when receiving the target response page fed back by a server;
adding the signature information to the form of the target response page and transmitting the target response page to a terminal;
receiving a target form request corresponding to the target response page transmitted by the terminal and verifying the signature information in a form included in the target form request; and
transmitting the target form request to the server if the verification is successful, otherwise
performing a prevention process on the target form request.

2. The method according to claim 1, wherein receiving a target form request corresponding to the target response page transmitted by the terminal and verifying the signature information in a form included in the target form request comprises:
receiving the target form request corresponding to the target response page transmitted by the terminal and obtaining request information of the target form request, wherein the request information at least includes a URL corresponding to the target form request, a parameter format of the preset read-only parameter and the signature information;
determining whether the target form request is a form request to be prevented based on the request information and a form request learning table stored locally; and
verifying the signature information in the form included in the target form request if YES.

3. The method according to claim 2, wherein the form request learning table records request information of all form requests obtained that need to be prevented after being processed by big-data and machine learning.

4. The method according to claim 2, wherein the method further comprises:
inserting the request information in the form request learning table and recording the target form request is in a learning phase, if the request information of the target form request corresponding to the target response page does not exist in the form request learning table when receiving the target response page fed back by the server.

5. The method according to claim 4, wherein after inserting the request information in the form request learning table, the method further comprising:
determining target form requests as form requests to be prevented if the target form requests carrying signature information that transmitted by at least a preset number of different terminals are received within a preset duration.

6. The method according to claim 2, wherein verifying the signature information in the form included in the target form request comprises:
determining whether the signature information in the form included in the target form request is decrypted based on a preset decryption algorithm, whether a decrypted parameter information is consistent with the preset read-only parameter, and whether the request information of the target form request is consistent with the request information of the target form request recorded in the form request learning table.

7. The method according to claim 2, further comprising:
determining a transmission terminal of the target form request if the target form request is a form request to be prevented and the target form request does not carry signature information;
determining a number of un-signed times of form requests corresponding to the transmission terminal; and
performing a prevention process on the target form request if the number of un-signed times is greater than a preset threshold, otherwise adding the number of un-signed times by one.

8. The method according to claim 2, further comprising:
seeking whether a same request information item is available in the form request learning table stored locally, and determining whether the target form is the form request to be prevented;
verifying the signature information in the form included in the target form request if YES; alternatively, transmitting the target form request directly to the server if NO.

9. The method according to claim 2, wherein,
recording form information of a form request that does not need to be prevented, and form information of a form request in a learning phase, by the form request learning table;
tagging each form information accordingly; and
determining whether a current form request is a form request to be prevented based on a corresponding tag when request information item of a certain form request is found in the form request learning table.

10. The method according to claim 6, further comprising:
decrypting the signature information in the form included in the target form request based on the preset decryption algorithm;
considering the signature information has been modified if the decryption is not performed normally; and
preventing the target form request.

11. The method according to claim 10, further comprising:
determining whether a decrypted parameter information is consistent with the preset read-only parameter of a corresponding form if the decryption is performed normally;
considering the signature information has been modified if it is inconsistency; and
preventing the target form request.

12. The method according to claim 11, further comprising:
extracting request information of the target form request if the decrypted parameter information is consistent with the preset read-only parameter of the corresponding form;
determining whether the request information of the target form request is consistent with the request information of the target form request recorded in the form request learning form; and
preventing the target form request if it is inconsistency.

13. The method according to claim 1, further comprising:
deleting the signature information in the target form request if the verification is successful; and
transmitting the target form request to the server.
transmitting the target form request to the server if the verification is successful, alternatively,
performing a prevention process on the target form request.

14. A WAF device, comprising a processor and a memory, wherein the memory stores at least one instruction, at least one program and a code set or an instruction set;
wherein the at least one instruction, the at least one program and the code set or the instruction set are loaded and executed by the processor to implement a method for transmitting a form request;
wherein the method comprises:
generating signature information based on a preset read-only parameter of a form in a target response page when receiving the target response page fed back by a server;
adding the signature information to the form of the target response page and transmitting the target response page to a terminal;
receiving a target form request corresponding to the target response page transmitted by the terminal and verifying the signature information in a form included in the target form request; and
transmitting the target form request to the server if the verification is successful, otherwise performing a prevention process on the target form request.

15. The WAF device according to claim 14, wherein receiving a target form request corresponding to the target response page transmitted by the terminal and verifying the signature information in a form included in the target form request comprises:
receiving the target form request corresponding to the target response page transmitted by the terminal and obtaining request information of the target form request, wherein the request information at least includes a URL corresponding to the target form request, a parameter format of the preset read-only parameter and the signature information;
determining whether the target form request is a form request to be prevented based on the request information and a form request learning table stored locally; and
verifying the signature information in the form included in the target form request if YES.

16. The WAF device according to claim 15, wherein the form request learning table records request information of all form requests obtained that need to be prevented after being processed by big-data and machine learning.

17. The WAF device according to claim 15, wherein the method further comprises:
inserting the request information in the form request learning table and recording the target form request is in a learning phase, if the request information of the target form request corresponding to the target response page does not exist in the form request learning table when receiving the target response page fed back by the server.

18. The WAF device according to claim 17, wherein after inserting the request information in the form request learning table, the method further comprising:
determining target form requests as form requests to be prevented if the target form requests carrying signature information that transmitted by at least a preset number of different terminals are received within a preset duration.

19. The WAF device according to claim 15, wherein verifying the signature information in the form included in the target form request comprises:
determining whether the signature information in the form included in the target form request is decrypted based on a preset decryption algorithm, whether a decrypted parameter information is consistent with the preset read-only parameter, and whether the request information of the target form request is consistent with the request information of the target form request recorded in the form request learning table.

20. A computer readable storage medium, storing at least one instruction, at least one program and a code set or an instruction set;
wherein the at least one instruction, the at least one program and the code set or the instruction set are loaded and executed by one or more processors to implement a method for transmitting a form request;
wherein the method comprises:
generating signature information based on a preset read-only parameter of a form in a target response page when receiving the target response page fed back by a server;
adding the signature information to the form of the target response page and transmitting the target response page to a terminal;
receiving a target form request corresponding to the target response page transmitted by the terminal and verifying the signature information in a form included in the target form request; and
transmitting the target form request to the server if the verification is successful, otherwise performing a prevention process on the target form request.
